(19) United States
(12) Patent Application Publication
(10) Pub. No.: US 2017/0327654 A1
(43) Pub. Date: Nov. 16, 2017

(54) OPTICAL FILM AND OPTICAL MEMBER USING OPTICAL FILM

(71) Applicant: SUMITOMO CHEMICAL COMPANY, LIMITED, Tokyo (JP)

(72) Inventors: Junichi IKEUCHI, Tsukuba-shi (JP); Akiko KISHIDA, Tsukuba-shi (JP)

(73) Assignee: SUMITOMO CHEMICAL COMPANY, LIMITED, Tokyo (JP)

(21) Appl. No.: 15/587,738

(22) Filed: May 5, 2017

(30) Foreign Application Priority Data
May 10, 2016 (JP) 2016-094596

(51) Int. Cl. C08J 5/18; C08K 3/36

(52) U.S. Cl. CPC C08J 5/18; C08K 3/36; C08J 2379/08

(57) ABSTRACT

Provided is an optical film capable of reducing yellow index, in which the sum of the numbers of concavities each satisfying the following conditions (1) and (2) is 4 or less per 10000 μm² of each of one surface of the film and the other surface of the film:
(1) The depth of the concavity is 200 nm or more, and
(2) The diameter of the part present at the depth of 200 nm or more of the concavity is 0.7 μm or more.

### BACKGROUND OF THE INVENTION

### Field of the Invention

The present invention relates to an optical film and an optical member using the optical film.

### Description of the Related Art

Conventionally, glass has been used as a material for various display members such as solar cells and displays. However, glass has disadvantages that it is easy to break and heavy, and has not a sufficient quality of material with respect to thinning, weight reduction, and flexibility of the display in recent years. Therefore, various films are being studied as a transparent member of a flexible device instead of glass as described in a Patent Document 1.

### PRIOR ART DOCUMENT

### Patent Documents

Patent Document 1: JP-A-2009-215412

### SUMMARY OF THE INVENTION

The present inventors have considered applying a transparent resin film such as a polyimide film as a transparent member of a flexible device instead of glass.

However, the conventional polyimide-based resin film often suffers from yellowish appearance and is often unsuitable for a transparent member such as a front plate of a flexible device from the viewpoint of appearance.

The present invention has been made in view of the above problems, and an object of the invention is to provide a transparent member of a flexible device capable of reducing yellow index.

One aspect of the optical film according to the present invention is an optical film in which the sum of the numbers of concavities each satisfying the following conditions (1) and (2) is 4 or less per 10000 μm² of each of one surface of the film and the other surface of the film:

(1) The depth of the concavity is 200 nm or more, and

(2) The diameter of the part present at the depth of 200 nm or more of the concavity is 0.7 μm or more.

Further, another aspect of the optical film according to the present invention is an optical film in which the number of concavities each satisfying the following conditions (1) and (2) is 0.1 or less per 10000 μm² of at least one surface of the film and the other surface which is the surface of the reverse side of the film:

(1) The depth of the concavity is 200 nm or more, and

(2) The diameter of the part present at the depth of 200 nm or more of the concavity is 0.7 μm or more.

According to the present invention, it is possible to reduce the yellow index of optical films.

It is preferable that the refractive index of the optical film is from 1.45 to 1.70.

When the film contains a polyimide-based polymer, physical properties suitable for front plates, such as flexibility and toughness, tend to be easily obtained.

It is preferable that the film has a total light transmittance of 85% or more according to JIS K 7136: 2000.

The film can be used as an optical member such as a front plate of a flexible device.

According to the present invention, it is possible to provide an optical film having a low yellow index.

### DETAILED DESCRIPTION OF THE PREFERRED EMBODIMENTS

In the optical film according to the present embodiment, the sum of the numbers of concavities on both sides wherein each concavity has a diameter of 0.7 μm or more in a part having a depth of 200 nm or more, is 4 or less per 20000 μm² in total on both sides, at one surface of the film and the other surface which is the surface of the reverse side of the film. The sum of the numbers of the concavities on both sides is preferably 1 or less, more preferably 0.5 or less.

Further, in the optical film according to the present embodiment, the concavity having a diameter of 0.7 μm or more in a part having a depth of 200 nm or more is preferably 0.1 or less per 10000 μm² area on at least one surface selected from one surface of the film and the other surface thereof. Here, the term of “one surface” refer a surface of the film, e.g. a surface on the viewing side or the rear side when the optical film have used a flexible device.

The upper limit of the depth of the part is 2 μm. On the other hand, the upper limit of the diameter of the part is 30 μm. The diameter of the part is the diameter of the circumscribed circle of the above part when viewed from the direction perpendicular to the front surface or the back surface.

The method for evaluating the number density of the concavities on the surface of the optical film, such as one surface of the film or the other surface thereof, is as follows.

Unevenness on both sides of the polyimide-based polymer film is observed using an optical interference film thickness gauge (Micromap (model: MM557N-M100), manufactured by Mitsubishi Chemical Systems, Inc)). Set values of the device are as follows. The observation range is 467.96 μm×351.26 μm, and the in-plane resolution is 0.73 μm/pix. The image is measured so that the flat part of the surface becomes Z=0, and the bitmap file of 680×480 pixels with a Z range of −1717.61 nm to 406.278 nm and a cutoff value of 5 μm is obtained.

### <Optics Setup>

Wavelength: 530 white

### Objective: ×10

### Body Tubes: 1× Body

### Relay Lens: No Relay

### Camera: SONY XC-ST30 ⅓″

### <Measurement Setup>

### Field X: 640

### Field Y: 480

### Sampling X: 1

### Sampling Y: 1

### Mode: Wave

### Z: −10 to 10 μm

The obtained image file related to concavities and convexities is analyzed by the following procedure using an image processing software “Image J”, and the number of concavities is counted.

(1) Conversion to 8-bit grayscale.

(2) Binarization with a threshold 182 (0 to 182 are black and 183 to 256 are white for each pixel).

(3) Define the blackened part as the concavity in the processing of (2), and count its number with Analyze Particles.

(4) The number of counted concavities is converted into the number density per 10000 μm² by the following equation.

(Number of concavities per 10000 μm²)=(Number of counts in (3))×10000÷164375.6

The concavities counted by the above (3) each has a part having a depth of 202 nm or more, which corresponds to a concavity in which the diameter of the circumscribed circle of the part is 0.73 μm or more.

When the film surface has the above-mentioned shape, it is possible to obtain an optical film in which change in yellow index is more suppressed even when the optical film is formed by the same raw material. Therefore, even when the optical film is made of a polyimide-based resin which tends to be yellowish due to the properties of raw materials, impurities, processing conditions, etc., a transparent member with a reduced yellow index can be obtained.

The refractive index of the above optical film is usually from 1.45 to 1.70, preferably from 1.50 to 1.66.

In the optical film, the total light transmittance in accordance with JIS K7136:2000 is usually 85% or more, preferably 90% or more.

In the optical film, Haze according to JIS K 7136: 2000 can be 1 or less, and it can also be 0.9 or less.

The thickness of the optical film is appropriately adjusted according to the type or the like of the flexible display, but is usually from 10 μm to 500 μm, preferably from 15 μm to 200 μm, and more preferably from 20 μm to 100 μm.

### (Material of Film)

### (Transparent Resin)

The optical film contains a transparent resin. Examples of the transparent resin are polyimide-based polymer, triacetyl cellulose (TAC), polyethylene terephthalate (PET), polyethylene naphthalate (PEN), cycloolefin polymer (COP), acrylic resin, polycarbonate resin, and the like. Among the transparent resins, a polyimide-based polymer is preferable from the viewpoint of superiority in heat resistance, flexibility, and rigidity.

### (Polyimide-Based Polymer)

In the present specification, the polyimide means a polymer having a repeating structural unit containing an imide group, and the polyamide means a polymer having a repeating structural unit containing an amide group. The polyimide-based polymer refers to a polymer comprising a polyimide and a repeating structural unit containing both an imide group and an amide group. Examples of the polymer containing a repeating structural unit containing both an imide group and an amide group include polyamideimide.

The polyimide-based polymer according to the present embodiment can be produced using a tetracarboxylic acid compound and a diamine compound, which will be described later, as a main raw materials, and has a repeating structural unit represented by the following formula (10). In the formula, G is a tetravalent organic group and A is a divalent organic group. The polyimide-based polymer may contain two or more kinds of structures represented by the formula (10) each having different G and/or A.

In addition, the polyimide-based polymer of the present embodiment may include a structure represented by the formula (11), (12), or (13) to the extent not significantly impairing various physical properties of the resulting polyimide-based polymer film.

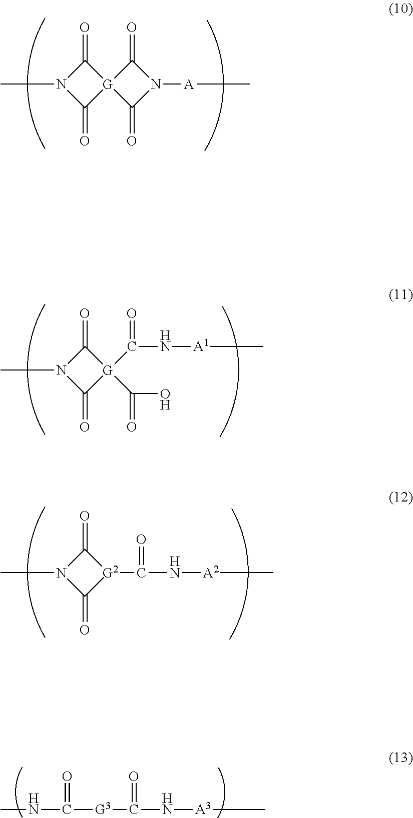

G and G¹ are each a tetravalent organic group, preferably an organic group which may be substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples of G and G¹ include a group represented by the following formula (20), (21), (22), (23), (24), (25), (26), (27) (28), or (29) and a tetravalent linear hydrocarbon group having 6 or less carbon atoms. The symbol * in the formula represents a bond and Z represents a single bond, —O—, —CH₂—, —CH₂—CH₂—, —CH(CH₃)—, —C(CH₃)₂—, —C(CF₃)₂—, —Ar—, —SO₂—, —CO—, —O—Ar—O—, —Ar—O—Ar—, —Ar—CH₂—Ar—, —Ar—C(CH₃)₂—Ar—, or —Ar—SO₂—Ar—. Ar represents an arylene group having 6 to 20 carbon atoms which may be substituted with a fluorine atom, and specific examples thereof include a phenylene group, a naphthalene group and a group having a fluorene ring. From viewpoint of suppressing yellow index of the produced film, a group represented by the following formula (20), (21), (22), (23), (24), (25), (26), or (27) is preferred.

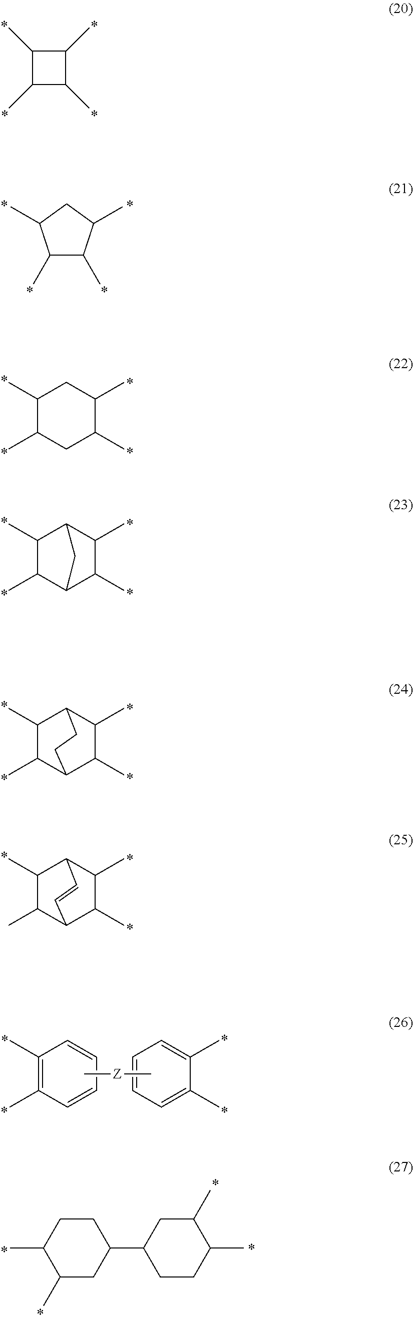

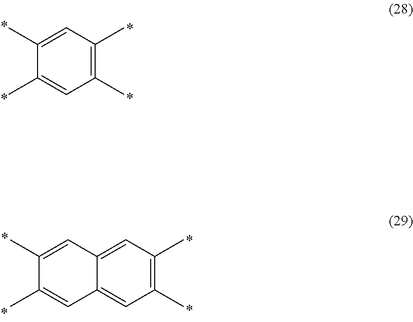

G² is a trivalent organic group, preferably an organic group which may be substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples of G² include a group in which any one of the bonds of the group represented by the formula (20), (21), (22), (23), (24), (25), (26), (27), (28), or (29) is substituted with a hydrogen atom, as well as include a trivalent linear hydrocarbon group having 6 or less carbon atoms.

G³ is a divalent organic group, preferably an organic group which may be substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples of G³ are a group in which two non-adjacent bonds of the group represented by the formula (20), (21), (22), (23), (24), (25), (26), (27), (28), or (29) are substituted with hydrogen atoms, and a linear hydrocarbon group having 6 or less carbon atoms.

A, A¹, A², and A³ are each a divalent organic group, preferably an organic group which may be substituted with a hydrocarbon group or a fluorine-substituted hydrocarbon group. The above organic groups can be an organic groups having 4 to 40 carbon atoms. The above hydrocarbon group or the fluorine-substituted hydrocarbon group can have 1 to 8 carbon atoms. Examples of A, A¹, A², and A³ include a group represented by the following formula (30), (31), (32), (33), (34), (35), (36), (37), or (38); a group formed by substituting the group represented by the following formula (30), (31), (32), (33), (34), (35), (36), (37), or (38) with a methyl group, a fluoro group, a chloro group, or a trifluoromethyl group; and a linear hydrocarbon group having 6 or less carbon atoms. The symbol * in the formula represents a bond, and Z¹, Z² and Z³ each independently represents a single bond, —O—, —CH₂—, —CH₂—CH₂—, —CH(CH₃)—, —C(CH₃)₂—, —C(CF₃)₂—, —SO₂—, or —CO—. In one example, Z¹ and Z³ are each —O— and Z² is —CH₂—, —C(CH₃)₂—, —C(CF₃)₂—, or —SO₂—. Z¹ and Z², and Z² and Z³ are preferably positioned at meta- or para-position to each ring, respectively.

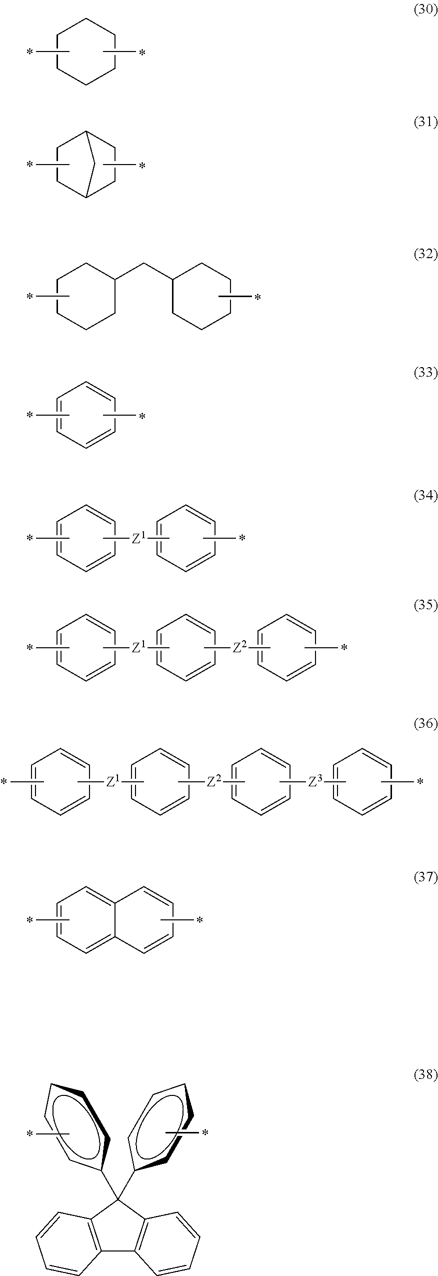

The polyamide according to the present embodiment is a polymer having a repeating structural unit represented by the formula (13) as a main component. Preferred specific examples are the same as G³ and A³ in the polyimide-based polymer. The polyamide may contain two or more kinds of structures represented by the formula (13) having different G³ and/or A³.

The polyimide-based polymer is obtained by, for example, polycondensation of a diamine and a tetracarboxylic acid compound (tetracarboxylic dianhydride or the like), and can be synthesized according to the method described in, for example, JP-A-2006-199945 or JP-A-2008-163107. As a commercially available product of the polyimide, NEOPULIM manufactured by Mitsubishi Gas Chemical Company, Inc. can be mentioned.

Examples of the tetracarboxylic acid compound used for the synthesis of polyimides include aromatic tetracarboxylic acid compounds (e.g. aromatic tetracarboxylic dianhydride) and aliphatic tetracarboxylic acid compounds (e.g. aliphatic tetracarboxylic dianhydride). The tetracarboxylic acid compound may be used singly or in combination of two or more kinds thereof. The tetracarboxylic acid compound used may be an analog of a tetracarboxylic acid compound, such as an acid chloride compound in addition to the dianhydride.

Specific examples of the aromatic tetracarboxylic dianhydride include 4,4′-oxydiphthalic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 3,3′,4,4′-diphenylsulfonetetracarboxylic dianhydride, 2,2-bis(3,4-dicarboxyphenyl)propane dianhydride, 2,2-bis(2,3-dicarboxyphenyl)propane dianhydride, 2,2-bis(3,4-dicarboxyphenoxyphenyl) propane dianhydride, 4,4′-(hexafluoroisopropylidene)diphthalic dianhydride, 1,2-bis(2,3-dicarboxyphenyl) ethane dianhydride, 1,1-bis(2,3-dicarboxyphenyl)ethane dianhydride, 1,2-bis(3,4-dicarboxyphenyl)ethane dianhydride, 1,1-bis(3,4-dicarboxyphenyl) ethane dianhydride, bis(3,4-dicarboxyphenyl)methane dianhydride, bis(2,3-dicarboxyphenyl)methane dianhydride, 4,4′-(p-phenylenedioxy)diphthalic dianhydride, 4,4′-(m-phenylenedioxy)diphthalic dianhydride, and 2,3,6,7-naphthalenetetracarboxylic dianhydride. These may be used singly or in combination of two or more kinds thereof.

As the aliphatic tetracarboxylic dianhydride, there can be mentioned cyclic or acyclic aliphatic tetracarboxylic dianhydrides. The cyclic aliphatic tetracarboxylic dianhydride is a tetracarboxylic dianhydride having an alicyclic hydrocarbon structure, and specific examples thereof include cycloalkanetetracarboxylic dianhydride (e.g. 1,2,4,5-cyclohexanetetracarboxylic dianhydride, 1,2,3,4-cyclobutanetetracarboxylic dianhydride, and 1,2,3,4-cyclopentanetetracarboxylic dianhydride), bicyclo[2.2.2]oct-7-ene-2,3,5,6-tetracarboxylic dianhydride, dicyclohexyl 3,3′-4,4′-tetracarboxylic dianhydride, and positional isomers thereof. These may be used singly or in combination of two or more kinds thereof. Specific examples of the acyclic aliphatic tetracarboxylic dianhydride include 1,2,3,4-butanetetracarboxylic dianhydride, 1,2,3,4-pentanetetracarboxylic dianhydride and the like, and these may be used singly or in combination of two or more kinds thereof.

Among the tetracarboxylic dianhydrides, from the viewpoints of high transparency and low coloring properties, 1,2,4,5-cyclohexanetetracarboxylic dianhydride, bicyclo[2.2.2]oct-7-ene-2,3,5,6-tetracarboxylic dianhydride, and 4,4′-(hexafluoroisopropylidene)diphthalic dianhydride are preferable.

In addition to the tetracarboxylic anhydride used for the polyimide synthesis described above, the polyimide-based polymers according to the present embodiment may be those obtained by the reaction of a tetracarboxylic acid, a tricarboxylic acid, and a dicarboxylic acid, as well as an anhydride and a derivative thereof, within the range to the extent that various physical properties of the resulting polyimide-based polymer film are not impaired.

Examples of the tricarboxylic acid compound include an aromatic tricarboxylic acid, an aliphatic tricarboxylic acid and an analog thereof such as an acid chloride compound and an acid anhydride, and two or more kinds thereof may be used in combination. Specific examples thereof include 1,2,4-benzenetricarboxylic anhydride; 2,3,6-naphthalene-tricarboxylic acid-2,3-anhydride; and a compound in which phthalic anhydride is linked with benzoic acid via a single bond, —O—, —CH₂—, —C(CH₃)₂—, —C(CF₃)₂—, —SO₂— or a phenylene group.

As the dicarboxylic acid compound, there are exemplified an aromatic dicarboxylic acid, an aliphatic dicarboxylic acid and an analog thereof such as an acid chloride compound and an acid anhydride, and two or more kinds thereof may be used in combination. Specific examples of the dicarboxylic acid compound include terephthalic acid; isophthalic acid; naphthalene dicarboxylicacid; 4,4′-biphenyldicarboxylic acid; 3,3′-biphenyldicarboxylic acid; a dicarboxylic acid compound of a linear hydrocarbon having 8 or less carbon atoms; and a compound formed by linking two benzoic acids via a single bond, —O—, —CH₂—, —C(CH₃)₂—, —C(CF₃)₂—, —SO₂— or a phenylene group.

The diamine used for the synthesis of polyimide may be an aliphatic diamine, an aromatic diamine, or a mixture thereof. In the present embodiment, the “aromatic diamine” represents a diamine in which an amino group is directly bonded to an aromatic ring, and a part of its structure may contain an aliphatic group or other substituent. The aromatic ring may be a monocyclic ring or a condensed ring, and examples thereof include, but not limited to, a benzene ring, a naphthalene ring, an anthracene ring, a fluorene ring, and the like. Among them, a benzene ring is preferred. The “aliphatic diamine” refers to a diamine in which an amino group is directly bonded to an aliphatic group, and a part of its structure may contain an aromatic ring or other substituent.

Examples of the aliphatic diamines include an acyclic aliphatic diamine (e.g. hexamethylene diamine), a cyclic aliphatic diamine (e.g. 1,3-bis(aminomethyl)cyclohexane, 1,4-bis(aminomethyl)cyclohexane, norbornanediamine, 4,4′-diaminodicyclohexylmethane), and the like, and these may be used singly or in combination of two or more kinds thereof.

Examples of the aromatic diamines include an aromatic diamine having one aromatic ring (e.g. p-phenylenediamine, m-phenylenediamine, 2,4-toluenediamine, m-xylylenediamine, p-xylylenediamine, 1,5-diaminonaphthalene, 2,6-diaminonaphthalene, etc.) and an aromatic diamine having two or more aromatic rings (e.g. 4,4′-diaminodiphenylmethane, 4,4′-diaminodiphenylpropane, 4,4′-diaminodiphenyl ether, 3,4′-diaminodiphenyl ether, 3,3′-diaminodiphenyl ether, 4,4′-diaminodiphenyl sulfone, 3,4′-diaminodiphenyl sulfone, 3,3′-diaminodiphenyl sulfone, 1,4-bis(4-aminophenoxy)benzene, 1,3-bis(4-aminophenoxy)benzene, 4,4′-diaminodiphenyl sulfone, bis[4-(4-aminophenoxy)phenyl]sulfone, bis[4-(3-aminophenoxy)phenyl]sulfone, 2,2-bis[4-(4-aminophenoxy)phenyl]propane, 2,2-bis[4-(3-aminophenoxy)phenyl]propane, 2,2′-dimethylbenzidine, 2,2′-bis(trifluoromethyl)benzidine, 4,4′-bis(4-aminophenoxy)biphenyl, 4,4′-diaminodiphenyl ether, 3,4′-diaminodiphenyl ether, 4,4′-diaminodiphenylmethane, 9,9-bis(4-aminophenyl)fluorene, 9,9-bis(4-amino-3-methylphenyl)fluorene, 9,9-bis(4-amino-3-chlorophenyl)fluorene, 9,9-bis(4-amino-3-fluorophenyl)fluorene, etc.). These compounds may be used singly or in combination of two or more kinds thereof.

Among the diamines, from the viewpoint of high transparency and low coloring property, it is preferable to use one or more members selected from the group consisting of aromatic diamines having a biphenyl structure. It is more preferable to use one or more members selected from the group consisting of 2,2′-dimethylbenzidine, 2,2′-bis(trifluoromethyl)benzidine, 4,4′-bis(4-aminophenoxy) biphenyl, and 4,4′-diaminodiphenyl ether. Still more preferred is 2,2′-bis(trifluoro-methyl)benzidine.

The polyimide-based polymers and the polyamides, which are polymers containing at least one repeating structural unit represented by the formula (10), (11), (12) or (13), are each a condensation type polymer that is a polycondensation product from a diamine and at least one compound selected from the group consisting of a tetracarboxylic acid compound (an analog of a tetracarboxylic acid compound such as an acid chloride compound and a tetracarboxylic dianhydride), a tricarboxylic acid compound (an analog of a tricarboxylic acid compound such as an acid chloride compound and a tricarboxylic dianhydride), and a dicarboxylic acid compound (an analog of a dicarboxylic acid compound such as an acid chloride compound). As the starting materials, dicarboxylic compounds (including analogs such as acid chloride compounds and the like) may be used in addition to these compounds mentioned above. The repeating structural unit represented by the formula (11) is usually derived from a diamine and a tetracarboxylic acid compound. The repeating structural unit represented by the formula (12) is usually derived from a diamine and a tricarboxylic compound. The repeating structural unit represented by the formula (13) is usually derived from a diamine and a dicarboxylic acid compound. Specific examples of the diamine and the tetracarboxylic acid compound are as described above.

The polyimide-based polymer and the polyamide according to the present embodiment have a weight average molecular weight of 10,000 to 500,000 in terms of a standard polystyrene. The weight average molecular weight is preferably 50,000 to 500,000, more preferably 100,000 to 400,000. When the weight average molecular weight of the polyimide-based polymer and the polyamide is too small, properties of bending resistance in forming a film tends to be lower. The higher the weight average molecular weight of the polyimide-based polymer and the polyamide, the higher the tendency to exhibit high bending resistance when formed into a film. However, if the weight average molecular weight of the polyimide-based polymer and the polyamide is too large, the viscosity of varnish tends to be increased and the processability tends to be lowered.

By including a fluorine-containing substituent, the polyimide-based polymer and the polyamide tend to have an improved elastic modulus as well as a reduced YI value when formed into a film. When the elastic modulus of the film is high, the occurrence of scratches and wrinkles tends to be suppressed. From the viewpoint of transparency of the film, the polyimide-based polymer and the polyamide preferably have a fluorine-containing substituent. Specific examples of the fluorine-containing substituent include a fluorine group and a trifluoromethyl group.

The content of fluorine atoms in the polyimide-based polymer and the polyamide is preferably 1% by mass or more and 40% by mass or less, more preferably 5% by mass or more and 40% by mass or less, based on the mass of the polyimide-based polymer or the polyamide.

### (Inorganic Particles)

The optical film according to the present embodiment may further contain an inorganic material such as inorganic particles in addition to the above polyimide-based polymer and/or the polyamide.

Silicon compounds such as silica particles and quaternary alkoxysilanes (e.g. tetraethyl orthosilicate (TEOS), etc.) are preferably used as the inorganic material, and from the viewpoint of the stability of varnish, silica particles are preferable.

The average primary particle diameter of the silica particles is preferably 10 nm to 100 nm, more preferably 20 nm to 80 nm. When the average primary particle diameter of the silica particles is 100 nm or less, the transparency tends to be improved. When the average primary particle diameter of the silica particles is 10 nm or more, the cohesive force of the silica particles is weakened, so that the silica particles are likely to be easy to handle.

The silica fine particles used according to the present embodiment may be a silica sol in which silica particles are dispersed in an organic solvent or the like, or may be a silica fine particle powder produced by a vapor phase method. However, from the viewpoint of easy handling, the silica fine sol is preferable.

The (average) primary particle diameter of the silica particles in the optical film can be determined by observation with a transmission electron microscope (TEM). The particle size distribution of the silica particles before forming the optical film can be obtained by a commercially available laser diffraction type particle size distribution meter.

In the optical film according to the present embodiment, the amount of the inorganic material is 0% by mass or more and 90% by mass or less relative to the total mass of the optical film. The amount of the inorganic material is preferably 10% by mass or more and 60% by mass or less, and more preferably 20% by mass or more and 50% by mass or less. When the compounding ratio of the polyimide-based polymer and the polyamide to the inorganic material (silicon material) is within the above range, transparency and mechanical strength of the optical film are likely to be compatible at the same time.

### (UV Absorber)

The optical film may contain one or two or more kinds of ultraviolet absorbers. By blending an appropriate ultraviolet absorber, it becomes possible to protect the underlying member from damage of ultraviolet rays. The ultraviolet absorber can be appropriately selected from those conventionally used as an ultraviolet absorber in the field of resin materials. The ultraviolet absorber may contain a compound that absorbs light having a wavelength of 400 nm or less. As the ultraviolet absorber, for example, at least one compound selected from the group consisting of a benzophenone-based compound, a salicylate-based compound, a benzotriazole-based compound, and a triazine-based compound can be mentioned. A resin containing such an ultraviolet absorber tends to be yellowish and are likely to exhibit the effect of the invention.

In the present specification, the term “based compound” means a derivative of a compound to which the “based” is attached. For example, “benzophenone-based compound” refers to a compound having benzophenone as a base skeleton and a substituent bonded to the benzophenone.

### (Other Additives)

The optical film may further contain other additives so long as its transparency and flexibility are not impaired. Examples of such other components include antioxidants, release agents, stabilizers, bluing agents, flame retardants, lubricants, thickeners and leveling agents.

The amount of the component other than the resin component and the inorganic material is preferably 0% by mass or more and 20% by mass or less with respect to the mass of the optical film. The amount of the component other than the resin component and the inorganic material is more preferably more than 0% by mass and 10% by mass or less.

According to such an optical film, the yellow index YI according to JIS K 7373: 2006 can be sufficiently lowered. For example, the yellow index YI can be set to 2.0 or less.

### (Production Method)

Next, an example of a method for producing the optical film of this embodiment will be described with an example of a case where the transparent resin is a polyimide-based polymer.

The varnish used for preparing the ultraviolet absorbing film according to the present embodiment can be prepared by, for example, mixing and stirring a reaction solution of a polyimide-based polymer and/or a polyamide obtained by selecting and reacting the tetracarboxylic acid compound, the diamine, and the other raw material; the solvent; and the ultraviolet absorber and the other additives used as necessary. A solution of a purchased polyimide-based polymer or a solution of a purchased solid polyimide-based polymer or the like may be used instead of the reaction solution of the polyimide-based polymer.

Then, the above-mentioned solution, such as varnish, etc., is applied onto a resin base material, an SUS belt, or a glass base material by a known roll-to-roll or batch method to form a coating film. The coating film is dried and peeled off from the base material to obtain a film. The film may be further dried after peeling.

Drying of the coating film is carried out at a temperature of 50° C. to 350° C. by appropriately evaporating the solvent under air, inert atmosphere or reduced pressure.

In order to obtain the above-mentioned optical film, it is important to control the roughness of the surface of the base material to a low level before applying the solution, such as varnish, thereon. Specifically, the arithmetic mean height Sa of the surface of the base material specified in ISO 25178 is preferably 1 nm or more and 20 nm or less, and more preferably 2 nm or more and 10 nm or less.

For the purpose of obtaining the optical film, it is preferable to heat the film at a temperature of 40 to 70° C. at the beginning of the drying step of varnish and the like. When the applicator or die contacts the solution surface, such as the surface of varnish, at the time of coating, minute unevenness sometimes occurs on the solution surface. However, by applying a heat treatment at a temperature of 40 to 70° C., such a minute unevenness on the surface is decreased, resulting in being able to suppress the occurrence of unnecessary concavities on the film surface.

Since vibrations and air currents of the base material at the time of drying the base material also cause roughening of the surface shape, it is preferable to suppress such vibrations and air currents.

Convection occurs in the varnish during the drying step, resulting in the formation of concavities on the surface in some cases. It is preferable to suppress the convection for suppressing unevenness of the surface.

When the surface roughness of the base material is sufficiently low, not only the number density of the concavities on the side surface of the base material of the optical film after drying can be reduced, but also the number density of the concavities on the free surface (the surface opposite to the base material) of the optical film after drying can be reduced. The convection of the varnish causes unevenness on the free surface, but since the surface roughness of the base material and foreign matters also affect such convection, the number density of the concavities on the free surface is also considered to be affected by the surface roughness on the surface side of the base material in the drying step.

It is preferable that the base material has an appropriate tackiness to the formed optical film. If the tackiness is too low, peeling of the film may occur during drying, resulting in causing breakage or the like. On the other hand, if the tackiness is too high, peeling of the film cannot be performed after the film formation in some cases. Since the surface roughness of the base material sometimes affects the tackiness, it is preferable to appropriately select the material and the surface roughness.

If the tackiness is too high, a release agent may be added to the solution, such as varnish, before application to the base material, but addition of a release agent may adversely affect the optical properties of the optical film.

Examples of the resin base material include PET, PEN, polyimide, polyamide imide, and the like. A resin that is excellent in heat resistance is preferable. In the case of a polyimide-based polymer film, a PET base material is preferable in terms of tackiness to the film and cost.

When the optical film is used as an optical member of a flexible device, the YI of the optical film is an important parameter from the viewpoint of appearance, energy saving and the like. Particularly when the optical film is used for a front plate, such YI is important because it directly affects the appearance of the device. Particularly, when the optical film is used for the front plate of the image display device, visibility is greatly affected by the YI, so that the optical film of the invention can be suitably used.

The YI may be affected by, for example, the thickness of the film, the kind of the resin, the kind and amount of the additive, and the like. Particularly in films containing the polyimide-based polymer, the drying temperature, the type and addition amount of the ultraviolet absorber, and the like are likely to affect the YI. When the drying temperature is high, the YI tends to be high, and particularly when the drying temperature exceeds 220° C., the YI is likely to be high. On the other hand, when the drying temperature is low, the solvent tends to be difficult to remove, and particularly when the drying temperature is lower than 190° C., the amount of the residual solvent may become larger.

### (Application)

Since such an optical film has a low yellow index YI, it can be suitably used as an optical member such as a front plate of a flexible device.

Examples of the flexible device include an image display device (a flexible display, an electronic paper, etc.), a solar cell, and the like. For example, the flexible display has a structure including a front plate/a polarizing plate protective film/a polarizing plate/a polarizing plate protective film/a touch sensor film/an organic EL element layer/a TFT substrate in the order from the front side, and a hard coat layer, a pressure-sensitive adhesive layer, an adhesive layer, a retardation layer, and the like may be included on the surface of the structure and between each layer. Such a flexible display can be used as an image display unit of tablet PCs, smartphones, portable game machines, or the like.

In addition, there can be obtained a laminate in which various functional layers such as an ultraviolet absorbing layer, a hard coat layer, a pressure-sensitive adhesive layer, a hue adjusting layer, and a refractive index adjusting layer are added onto the surface of the optical film.

### EXAMPLES

Hereinafter, the present invention will be described more specifically by way of Examples and Comparative Examples, but the present invention is not limited to the following Examples.

### Example 1

### (Prescription of Varnish 1)

A polyimide-based polymer having a glass transition temperature of 390° C. (“NEOPULIM C-6A20-G” manufactured by Mitsubishi Gas Chemical Company, Inc.) was prepared. A γ-butyrolactone solution (solution viscosity 108.5 Pa·s) containing this polyimide-based polymer with a concentration of 22% by mass, a dispersion liquid in which silica particles having a solid content concentration of 30% by mass were dispersed in γ-butyrolactone, and a dimethylacetamide solution of an alkoxysilane having an amino group were mixed and stirred for 30 minutes to obtain a varnish 1 as a mixed solution. In the varnish 1, the mass ratio of the silica particles and the polyimide-based polymer was 30:70 and the amount of the alkoxysilane having an amino group was 1.67 parts by mass relative to 100 parts by mass of the total of the silica particles and the polyimide-based polymer.

### (Film Formation)

The varnish 1 prepared by the above method was cast-formed into a PET film (Toyobo A4100: arithmetic mean height Sa of the surface=4.2 nm) as a base material, heat-treated at 50° C. for 30 minutes and at 140° C. for 10 minutes to obtain a polyimide-based polymer film. The obtained polyimide-based polymer film was peeled from the PET film and further heat-treated at 210° C. for 1 hour under nitrogen. The obtained polyimide-based polymer film had a thickness of 50 μm and a refractive index of 1.57.

### Example 2

A varnish 2 was prepared in the same prescription as in Example 1, using a NEOPULIM solution (concentration 22.3% by mass, solution viscosity 89.8 Pa·s) with different production days, and the varnish 2 prepared was cast-formed into a PET film (Toyobo A4100: arithmetic mean height Sa on the surface=4.2 nm), heat-treated at 50° C. for 30 minutes and at 140° C. for 10 minutes to obtain a polyimide-based polymer film. The obtained polyimide-based polymer film was peeled from the PET film and further heat-treated at 210° C. for 1 hour under nitrogen. The obtained polyimide-based polymer film had a thickness of 50 μm and a refractive index of 1.57.

The resultant polyimide-based polymer film was different from Example 1 in the YI due to a slight difference in color tone of the polyimide.

### Comparative Example 1

A polyimide-based polymer film was obtained in the same manner as in Example 1 except that the same varnish as in Example 1 was used and the PET film as the base material was changed to Toyobo E5001 (arithmetic mean height Sa on the surface=21.2 nm).

### Comparative Example 2

A polyimide-based polymer film was obtained in the same manner as in Example 2 except that the same varnish as in Example 2 was used and the PET film as the base material was changed to Toyobo E5001 (arithmetic mean height Sa on the surface=21.2 nm).

### (Evaluation of YI of Polyimide-Based Polymer Film)

The yellow index (YI) of the film of Example was measured by a UV-visible near-infrared spectrophotometer V-670 manufactured by JASCO Corporation according to JIS K 7373: 2006. After background measurement in the absence of a sample, the film was set in a sample holder and transmittance for light of 300 nm to 800 nm was measured to obtain tristimulus values (X, Y, Z). The YI was calculated based on the following equation:

YI=100×(1.2769X−1.0592Z)/Y

### (Evaluation of Total Light Transmittance Tr of Polyimide-Based Polymer Film)

The total light transmittance of the film was measured by a fully automated direct reading haze computer HGM-2DP manufactured by Suga Test Instruments Co., Ltd. according to JIS K 7136: 2000.

### (Evaluation of Number Density of Concavities on Surface of Polyimide-Based Polymer Film)

As described above, both sides of the polyimide-based polymer film were observed using an optical interference thickness gauge (Micromap (MM557N-M100 model), manufactured by Mitsubishi Chemical Systems, Inc)).

The obtained image file related to unevenness was analyzed by the above procedure using the image processing software “Image J”, and the number of concavities in which the diameter of the part having a depth of 202 nm or more was 0.73 μm or more was counted.

### (Evaluation of Arithmetic Mean Height Sa on PET Film Surface)

Using the optical interference thickness gauge (Micromap (MM557N-M100 model), manufactured by Mitsubishi Chemical Systems, Inc)), the unevenness of the PET film surface was observed under the same conditions as for the polyimide-based polymer film, and the arithmetic mean height Sa on the surface was determined based on the obtained data.

These results are shown in Table 1. In both of the varnish 1 and the varnish 2, the YI was a lower numerical value in the case of a film prepared by reducing the number of concavities.

### Example 3

Polyimide (KPI-300 MXF(100) manufactured by Kawamura Sangyo Co., Ltd.) was prepared. This polyimide was dissolved in a 9:1 mixed solvent of N,N-dimethylacetamide and γ-butyrolactone, and 0.8 part by mass of Sumisorb 350 manufactured by Sumika Chemtex Co., Ltd. was added as a UV absorber relative to 100 parts by mass of polyimide to prepare a varnish 3 (concentration of polyimide: 17% by mass). The varnish 3 prepared was cast-formed into a PET film (Toyobo A4100: arithmetic mean height Sa on the surface=4.2 nm) as a base material, and heat-treated at 50° C. to 70° C. for 60 minutes. The formed transparent resin film was peeled off from the PET film, and the peeled transparent resin film was heated at 200° C. for 40 minutes in the air atmosphere and then dried. The film had a thickness of 79 μm, and its refractive index was 1.56.

[Table 1]

| | | | Sa on the | | Number density of | | |
|---|---|---|---|---|---|---|---|
| | | | surface of | Number density of | concavities | | |
| | | | PET base | concavities | (base material | | |
| | | PET base | material | (free surface side) | surface side) | YI | Total light |
| | Varnish | material | [nm] | [1/10000 μm²] | [1/10000 μm²] | [—} | transmittance [%] |
| Example 1 | Varnish 1 | Toyobo | 4.2 | <0.1 | <0.1 | 1.9 | 92.3 |
| | | A4100 | | | | | |
| Comparative | Varnish 1 | Toyobo | 21.2 | 0.2 | 5.2 | 2.4 | 92.3 |
| example 1 | | E5001 | | | | | |
| Example 2 | Varnish 2 | Toyobo | 4.2 | <0.1 | 0.4 | 1.3 | 92.3 |
| | | A4100 | | | | | |
| Comparative | Varnish 2 | Toyobo | 21.2 | 0.7 | 3.9 | 1.7 | 92.5 |
| example 2 | | E5001 | | | | | |
| Example 3 | Varnish 3 | Toyobo | 4.2 | <0.1 | <0.1 | 2.0 | 92.0 |
| | | A4100 | | | | | |

What is claimed is:

1. An optical film in which the sum of the numbers of concavities each satisfying the following conditions (1) and (2) is 4 or less per 10000 μm² of each of one surface of the film and the other surface of the film:
(1) The depth of the concavity is 200 nm or more, and
(2) The diameter of the part present at the depth of 200 nm or more of the concavity is 0.7 μm or more.

2. An optical film in which the number of concavities each satisfying the following conditions (1) and (2) is 0.1 or less per 10000 μm² of at least one surface selected from one surface and the other surface of the film:
(1) The depth of the concavity is 200 nm or more, and
(2) The diameter of the part present at the depth of 200 nm or more of the concavity is 0.7 μm or more.

3. The optical film according to claim 1, which has a refractive index of from 1.45 to 1.70.

4. The optical film according to claim 1, which comprises a polyimide-based polymer.

5. The optical film according to claim 1, which has a total light transmittance of 85% or more in accordance with JIS K 7136: 2000.

6. An optical member of a flexible device using the optical film according to claim 1.

7. A front plate of a flexible device using the optical film according to claim 1.

8. The optical film according to claim 2, which has a refractive index of from 1.45 to 1.70.

9. The optical film according to claim 2, which comprises a polyimide-based polymer.

10. The optical film according to claim 2, which has a total light transmittance of 85% or more in accordance with JIS K 7136: 2000.

11. An optical member of a flexible device using the optical film according to claim 2.

12. A front plate of a flexible device using the optical film according to claim 2.

13. The optical film according to claim 1, further the number of concavities each satisfying the following conditions (1′) and (2′) is 0.1 or less per 10000 μm² of at least one surface selected from one surface and the other surface of the film:
(1′) The depth of the concavity is 200 nm or more, and
(2′) The diameter of the part present at the depth of 200 nm or more of the concavity is 0.7 μm or more.

14. The optical film according to claim 13, which has a refractive index of from 1.45 to 1.70.

15. The optical film according to claim 13, which comprises a polyimide-based polymer.

16. The optical film according to claim 13, which has a total light transmittance of 85% or more in accordance with JIS K 7136: 2000.

17. An optical member of a flexible device using the optical film according to claim 13.

18. The optical film according to claim 15, which has a total light transmittance of 85% or more in accordance with JIS K 7136: 2000.

19. An optical member of a flexible device using the optical film according to claim 15.

20. A front plate of a flexible device using the optical film according to claim 19.
